(19) United States
(12) Patent Application Publication
(10) Pub. No.: US 2012/0242075 A1
(43) Pub. Date: Sep. 27, 2012

(54) GOLD-COLORED THIN-FILM ELEMENT WITH MULTILAYER STRUCTURE

(75) Inventor: Hans Lochbihler, Munchen (DE)

(73) Assignee: Giesecke & Devrient GmbH, Munich (DE)

(21) Appl. No.: 13/514,747

(22) PCT Filed: Dec. 10, 2010
(86) PCT No.: PCT/EP2010/007546

§ 371 Date: Jun. 8, 2012

(30) Foreign Application Priority Data
Dec. 14, 2009 (DE) 10 2009 058 243.6

(51) Int. Cl. B42D 15/00

(52) U.S. Cl. 283/85

(57) ABSTRACT

The invention relates to a thin-film element (30) with multilayer structure for security papers, value documents and the like, which, upon viewing in incident light, appears gold-colored and which as at least two semitransparent mirror layers (34, 38) and at least one dielectric spacer layer (36) arranged between the at least two mirror layers, so that, upon measuring the transmission of unpolarized light in the blue wavelength range from 420 nm to 490 nm, there is found a resonance with a full width at half maximum of 70 to 150 nm.

The invention relates to a thin-film element with multilayer structure for security papers, value documents and the like, which appears gold-colored upon viewing in incident light and which has at least two semi-transparent, i.e. partly transparent, mirror layers and at least one dielectric spacer layer arranged between the at least two mirror layers. The invention further relates to a see-through security element and a data carrier with such a thin-film element.

Data carriers, such as value documents or identification documents, or other objects of value, such as branded articles, are frequently provided for protection with security elements which permit a check of the authenticity of the data carrier and which at the same time serve as protection from unauthorized reproduction. For some years see-through windows have turned out to be attractive security elements in polymer banknotes and recently also in paper banknotes, since they permit the employment of a multiplicity of security features.

A special role in authenticity protection is played by security elements with viewing-angle-dependent effects, since these cannot be reproduced even with the most modern copying machines. Here the security elements are equipped with optically variable elements which, from different viewing angles, convey to the viewer a different image impression and for example show, depending on the viewing angle, a different color impression or brightness impression and/or a different graphical motif

In this context it is known to employ security elements with multilayer thin-film elements, whose color impression changes for the viewer with the viewing angle, and, upon tilting the thin-film element, for example changes from green to blue, from blue to magenta or from magenta to green. The occurrence of such color changes upon tilting a thin-film element is in the following referred to as color-shift effect.

A further special role in authenticity protection is played by see-through security elements which show a contrast between their appearance in plan view and in transmitted light.

From DE 10 2005 021 514 A1 a security element for a value document is known that has a mintage-metal colored coating. The mintage-metal colored coating contains a layer sequence with a reflector layer, a dielectric spacer layer and a thin metal layer. According to a preferred embodiment the coating of the security element is gold-colored and the metal layer essentially consists of gold.

Proceeding therefrom it is the object of the invention to provide a cost-efficient thin-film element having an attractive visual appearance and high forgery resistance.

This object is achieved by the thin-film element, the see-through security element and the data carrier according to the independent claims. Developments of the invention are the subject matter of the subclaims.

The thin-film element according to the present invention can be manufactured without using gold. In the thin-film element according to the invention the gold-colored visual impression is almost independent of the viewing angle. By means of the present disclosure it is further shown how the gold-colored thin-film element can be integrated in micro structures. Thereby for example gold-colored motifs can be produced in micro-lens magnification arrangements.

An aspect of the invention relates to a thin-film element with multilayer structure for security papers, value documents and the like, which, upon viewing in incident light, appears gold-colored, and which has at least two semitransparent mirror layers and at least one dielectric spacer layer arranged between the at least two mirror layers, so that upon measuring the transmission of unpolarized light in the blue wavelength range from 420 to 490 nm a resonance with a full width at half maximum of 70 to 150 nm.

The at least two semitransparent mirror layers do not necessarily have to be formed by a homogeneous, continuous film. They can also be formed by clusters, i.e. a film with discontinuations. The optical effect of the Fabry-Perot resonance occurs also for this case and produces a gold color for the viewer.

Preferably the resonance showing upon measuring the transmission of unpolarized light in the blue wavelength range from 420 to 490 nm with a full width at half maximum of 70 to 150 nm is the only resonance in the visible range.

The two mirror layers are for example formed of silver or of a silver alloy, whereby the dielectric spacer layer with a thickness h and a refractive index v fulfills the relation 120 nm<h*v<170 nm. This dielectric layer preferably consists of a homogeneous medium, e.g. SiO₂. However, it can also consist of an inhomogeneous medium, e.g. SiO₂ with nanoparticles (that are e.g. made of latex) embedded therein. In this case v is characterized by the effective or average refractive index. The material of the spacer layer preferably is SiO₂. Further preferably, a semitransparent layer formed of copper is introduced within the dielectric spacer layer.

The two mirror layers can alternatively be formed of silver or a silver alloy, whereby the dielectric spacer layer with a thickness h and a refractive index v fulfills the relation 340 nm<h*v<400 nm. Here the dielectric spacer layer is preferably formed of SiO₂. However, it can also consist of an inhomogeneous medium, e.g. SiO₂ with nanoparticles (which are made of latex) embedded therein. Further preferably, a semitransparent layer formed of copper is introduced within the dielectric spacer layer.

The two mirror layers can alternatively be formed of silver or a silver alloy, whereby the dielectric spacer layer with a thickness h and a refractive index v fulfills the relation 120 nm<h*v<190 nm. Here the dielectric spacer layer is preferably formed of SiO₂. However, it can also consist of an inhomogeneous medium, e.g. SiO₂ with nanoparticles (that are e.g. made of latex) embedded therein.

The two mirror layers can alternatively be formed of ZnS or TiO₂, whereby the dielectric spacer layer with a thickness h and a refractive index v fulfills the relation 100 nm<h*v<170 nm and v is smaller than the refractive index of the mirror layer. Here the dielectric spacer layer is preferably formed of SiO₂. However, it can also consist of an inhomogeneous medium, e.g. SiO₂ with nanoparticles (that are e.g. made of latex) embedded therein.

The two mirror layers can alternatively be formed of a semimetal, e.g. silicon or germanium. In the case of silicon these layers preferably respectively have a thickness of 10 nm to 35 nm. Here the dielectric spacer layer is preferably formed of SiO₂. However, it can also consist of an inhomogeneous medium, e.g. SiO₂ with nanoparticles (that are e.g. made of latex) embedded therein.

The thin-film element according to the invention advantageously appears blue in transmitted light and has almost no color-shift effect.

The thin-film element according to the invention is preferably present in the form of patterns, characters or a coding.

The thin-film element according to the invention is preferably combined with a relief structure. It is particularly preferred that the thin-film element is applied to a diffractive relief structure, a micro-optic relief structure or sublambda structures.

A further aspect of the invention relates to a see-through security element for security papers, value documents and the like, with a carrier and a thin-film element applied on the carrier, whereby the thin-film element is the above-mentioned thin-film element.

A further aspect of the invention relates to a data carrier with the above-mentioned thin-film element, whereby the thin-film element is arranged in or above a transparent window region or a through opening of the data carrier.

The data carrier is preferably a value document, such as a banknote, in particular a paper banknote, a polymer banknote, a foil composite banknote or an identification card.

The invention is based on the finding that in a Fabry-Perot resonator having two semitransparent mirror layers and a dielectric spacer layer arranged between, both upon viewing in incident light and upon viewing in transmitted light, a strong color saturation can be achieved, when the multilayer structure is so constituted that upon measuring the transmission of unpolarized light in the blue wavelength range from 420 to 490 nm there is found a resonance of a full width at half maximum of 70 to 150 nm. The formulation “a resonance of a full width at half maximum of 70 to 150 nm within the blue wavelength range from 420 nm to 490 nm” means that the maximum of the resonance is within the blue wavelength range from 420 to 490 nm.

The resonance properties as well as the color of the thin-film element upon viewing in incident light and in transmitted light can be determined by the choice of the spacer layer, i.e. the thickness and the refractive index of the spacer layer, and by the choice of the semitransparent mirror layers.

The thin-film element according to the invention has a gold color when viewed in incident light. Upon viewing in transmitted light there results a blue color tone that has almost no color-shift effect.

The thin-film element according to the invention is preferably so constituted that upon measuring the transmission of unpolarized light in the visible range there is found only one single resonance with a of a full width at half maximum of 70 to 150 nm.

Further preferably, the thin-film element according to the invention is so constituted that upon measuring the transmission of unpolarized light in the visible range there is found only one single resonance with a of a full width at half maximum of 90 to 120 nm. Both upon viewing in incident light and upon viewing in transmitted light the color saturation is then particularly strong.

In an advantageous variant of the invention the two mirror layers are formed of silver or a silver alloy and the dielectric spacer layer with a thickness h and a refractive index v fulfills the relation 120 nm<h*v<170 nm. In an alternative advantageous variant of the invention the two mirror layers are formed of silver or a silver alloy and the dielectric spacer layer with a thickness h and a refractive index v fulfills the relation 340 nm<h*v<400 nm. It is further preferred that the two semitransparent mirror layers are formed of silver (Ag) or of a silver alloy and the dielectric spacer layer is formed of SiO₂. It is particularly preferred that the two semitransparent mirror layers are formed of silver (Ag) or a silver alloy, the dielectric spacer layer is formed of SiO₂ and within the dielectric spacer layer there is introduced a semitransparent layer formed of copper.

In a further advantageous variant of the invention the two semitransparent mirror layers are formed of aluminum (Al) or an aluminum alloy and the dielectric spacer layer with a thickness h and a refractive index v fulfills the relation 120 nm<h*v<190 nm. The dielectric spacer layer is preferably formed of SiO₂.

In a further advantageous variant of the invention the two mirror layers are formed of a high-refractive dielectric material, in particular of ZnS or TiO₂, and the dielectric spacer layer with a thickness h and a refractive index v fulfills the relation 100 nm<h*v<170 nm, wherein v is smaller than the refractive index of the mirror layer. It is particularly preferred that the two semitransparent mirror layers are formed of zinc sulfide (ZnS) or titanium dioxide (TiO₂), and the dielectric spacer layer is formed of SiO₂.

In a further advantageous variant of the invention the two mirror layers are formed of a semimetal, in particular of silicon or germanium. In the case of silicon the thickness of the mirror layers preferably amounts to respectively 10 nm to 35 nm. It is preferred in particular that the two semitransparent mirror layers are formed of silicon, and the dielectric spacer layer is formed of SiO₂.

The multilayer structure of the thin-film element according to the invention preferably has a symmetric three-layer configuration, with a first semitransparent mirror layer, a dielectric spacer layer and a second semitransparent mirror layer that consists of the same material as the first mirror layer and has the same layer thickness or almost the same layer thickness as the first mirror layer.

The thin-film element according to the invention, which appears gold-colored upon viewing in incident light, advantageously has a symmetric three-layer configuration chosen from the following layer sequences:

### 5 to 15 nm Al/85 to 125 nm SiO₂/5 to 15 nm Al;

### 15 to 25 nm Ag/80 to 105 nm SiO₂/15 to 25 nm Ag;

### 65 to 75 nm ZnS/70 to 100 nm SiO₂/65 to 75 nm ZnS.

Furthermore the thin-film element according to the invention, which, upon viewing in incident light, appears gold-colored, advantageously has a symmetric three-layer configuration chosen from the two following layer sequences:

10 to 35 nm silicon/140 to 180 nm SiO₂/10 to 35 nm silicon;
10 to 35 nm silicon/90 to 130 nm SiO₂/10 to 35 nm silicon.
The latter three-layer configuration shows almost no change in color tone even for flat angles of incidence (e.g. >60°.

Examinations of the chromaticity by means of thin-film elements with dielectric spacer layers of different layer thickness have shown that the color space is passed through periodically. The thin-film element according to the invention thus does not only advantageously have a symmetric three-layer configuration with the layer sequence 15 to 25 nm Ag/80 to 105 nm SiO₂/15 to 25 nm Ag, but advantageously has a symmetric three-layer configuration chosen from the following layer sequences:

### 15 to 25 nm Ag/220 to 260 nm SiO2/15 to 25 nm Ag;

### 15 to 25 nm Ag/420 to 460 nm SiO₂/15 to 25 nm Ag.

However, a thin-film element with a three-layer configuration with the layer sequence 15 to 25 nm Ag/80 to 105 nm SiO₂/15 to 25 nm Ag is preferred, since this variant is particularly color-accurate.

The thin-film element according to the invention can in particular have a symmetric three-layer configuration chosen from the following layer sequences:

### 10 nm Al/120 nm SiO₂/10 nm Al;

### 20 nm Ag/90 nm SiO₂/20 nm Ag;

### 70 nm ZnS/80 nm SiO₂/70 nm ZnS;

### 20 nm Ag/240 nm SiO₂/20 nm Ag;

### 20 nm Ag/440 nm SiO₂/20 nm Ag.

Further, the thin-film element according to the invention can in particular have a symmetric three-layer configuration chosen from the following two layer sequences:

15 nm silicon/160 nm SiO₂/15 nm silicon;
15 nm silicon/110 nm SiO₂/15 nm silicon.

The latter three-layer configuration shows almost no change in color tone also for flat angles of incidence (e.g. >60°.

The multilayer structure of the thin-film element according to the invention advantageously has a symmetric five-layer configuration, with a first mirror layer, a dielectric spacer layer and a second mirror layer that consists of the same material as the first mirror layer and has the same layer thickness, or almost the same layer thickness, as the first mirror layer, whereby a layer formed of copper (Cu) is embedded within the dielectric spacer layer. By an embedding of a copper layer within the dielectric spacer layer the color tone of the gold color can be improved. The thin-film element according to the invention can in particular have a symmetric five-layer configuration with the following layer sequence:

### 20 nm Ag/45 nm SiO₂/6 nm Cu/45 nm SiO₂/20 nm Ag.

Through more complex layer sequences an even better adjustment of the color tone can take place.

The thin-film elements according to the invention can be manufactured through thermal vaporization, electron-beam vaporization (EBV) or sputtering.

In advantageous embodiments the thin-film element is present in the form of patterns, characters or a coding. This also includes the possibility that a full-surface thin-film element is provided with gaps in the form of patterns, characters or a coding.

The thin-film element according to the invention can advantageously be combined with a relief structure, such as a diffractive relief structure (e.g. a hologram), a micro-optic relief structure (e.g. microlens structure, 3D-representation of saw tooth structures) or a sublambda structure (e.g. subwavelength grating, moth-eye structures), and can in particular be applied on such a relief structure.

The thin-film element according to the invention can also be combined with optically variable coatings, in particular with coatings which themselves have a combination of color-variable and color-constant regions.

The invention also relates to a see-through security element for security papers, value documents and the like, with a carrier and a thin-film element of the described type applied on the carrier. The carrier can have a radiation-curing lacquer (for example a UV lacquer). The lacquer can be present on a transparent carrier foil (for example a PET foil). In particular the carrier can comprise a UV-curing inorganic-organic hybrid polymer, which is distributed e.g. under the trademark name “Ormocer”.

The invention also relates to a data carrier with a thin-film element of the described type, whereby the thin-film element is arranged in particular in or above a transparent window region or a through opening of the data carrier. The data carrier can in particular be a value document, such as a banknote, in particular a paper banknote, a polymer banknote or a foil composite banknote, or an identification card, such as a credit card, bank card, cash card, authorization card, a national identity card or a passport personalization sheet.

Further embodiment examples as well as advantages of the invention will be explained hereinafter with reference to the figures, in whose representation a rendition that is true to scale and to proportion has been dispensed with in order to increase the clearness. The different embodiment examples are not limited to use in the concretely described form, but can also be combined with each other.

The figures are described as follows:

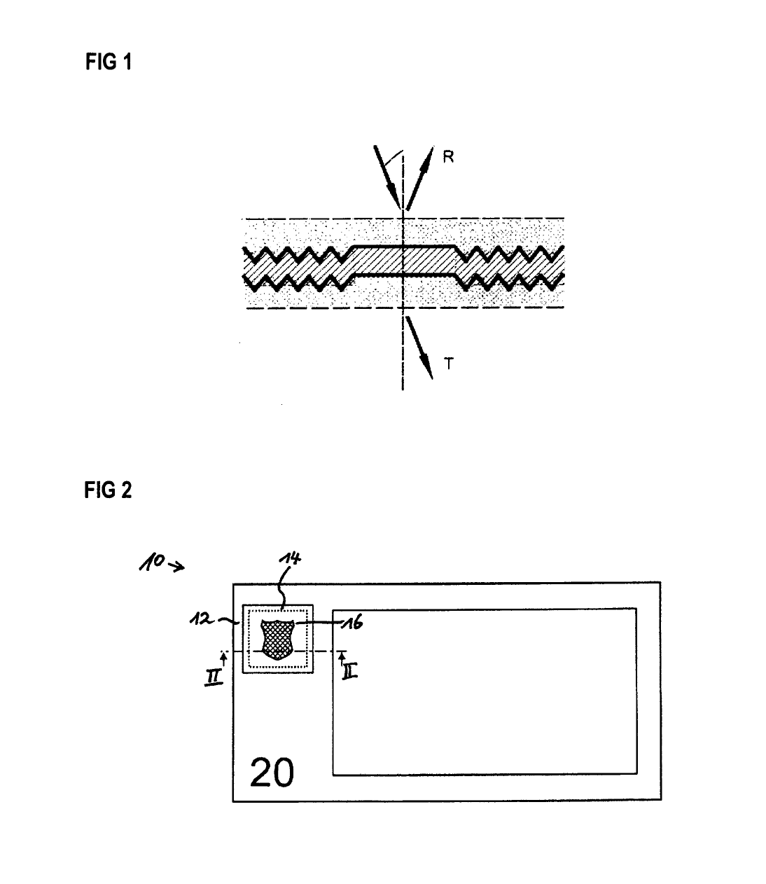

FIG. 1 a thin-film element according to the invention that is surrounded by a micro-optic relief structure;

FIG. 2 a schematic representation of a banknote with a see-through security element according to the invention;

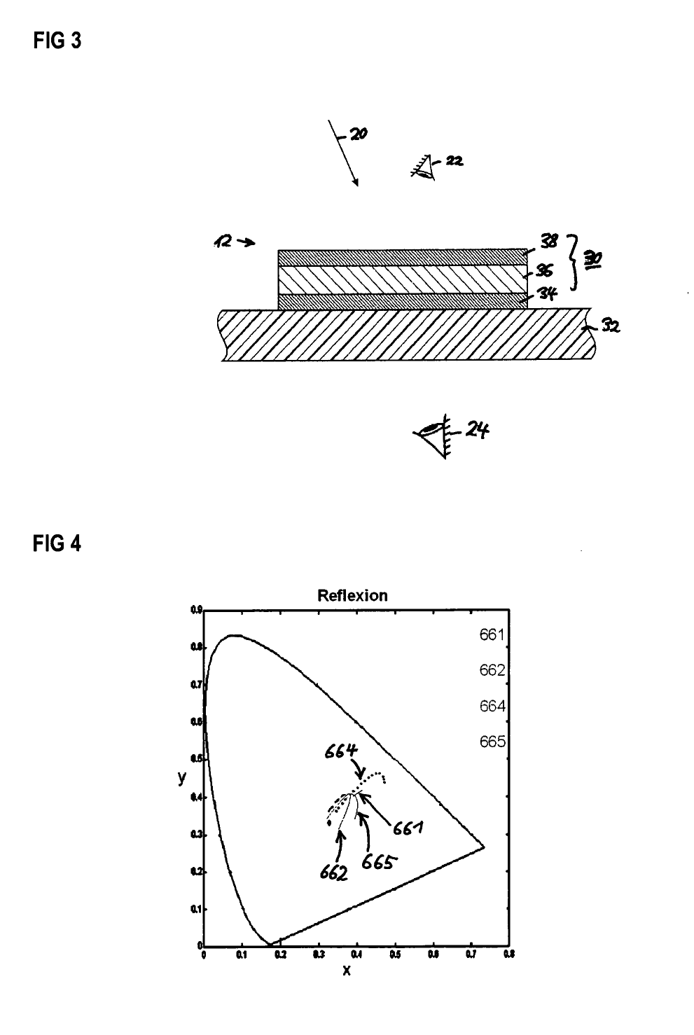

FIG. 3 the see-through security element of FIG. 1 along the line II-II in cross section;

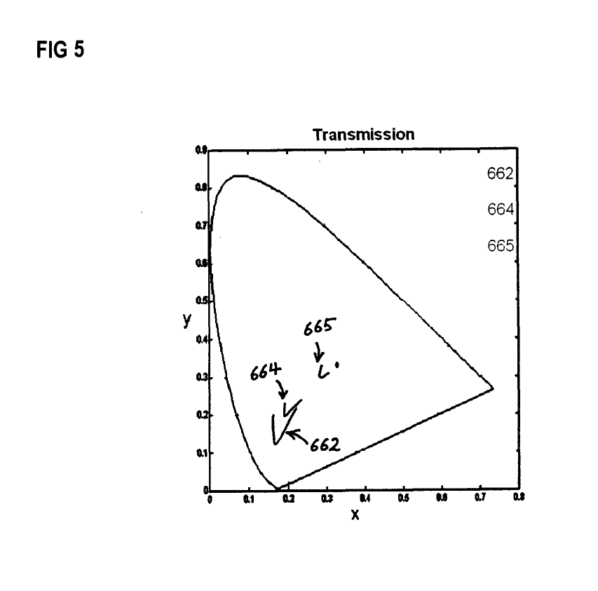

FIG. 4 the reflection as a function of the incidence angle θ=0°-60° in a CIE standard chromaticity diagram for the layers (661) Au; (662) 10 nm Al, 120 nm SiO₂, 10 nm Al; (664) 20 nm Ag, 90 nm SiO₂, 20 nm Ag; and (665) 70 nm ZnS, 80 nm SiO₂, 100 nm ZnS;

FIG. 5 the transmission as a function of the incidence angle θ=0°-60° in a CIE standard chromaticity diagram for the layer configurations (662) 10 nm Al, 120 nm SiO₂, 10 nm Al; (664) 20 nm Ag, 90 nm SiO₂, 20 nm Ag; and (665) 70 nm ZnS, 80 nm SiO₂, 100 nm ZnS;

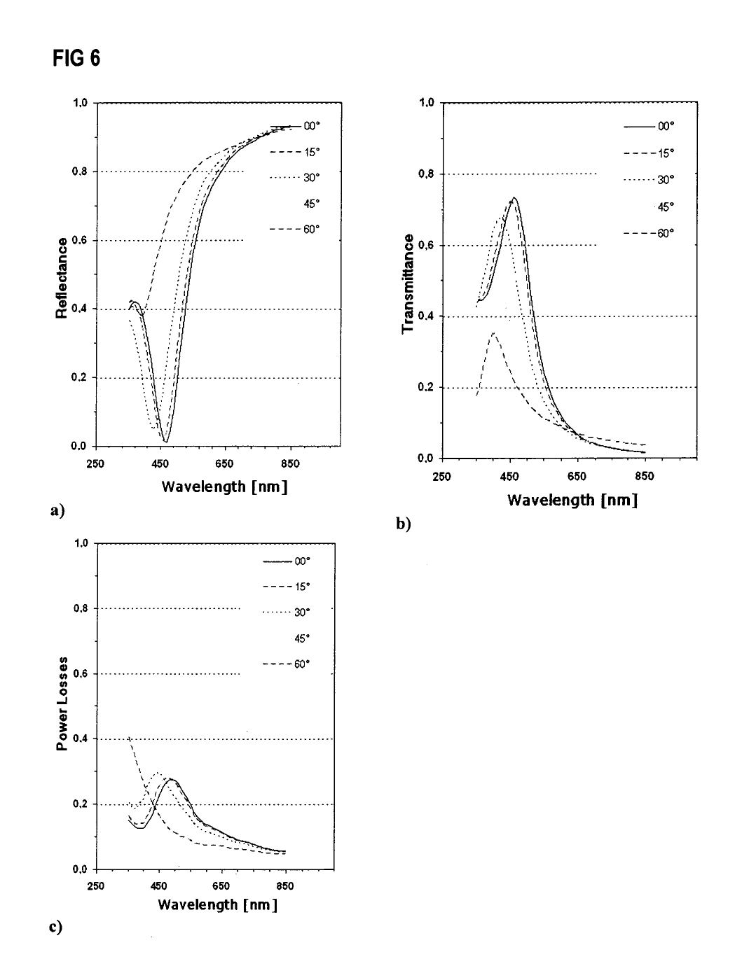

FIG. 6 reflection-, transmission- and absorption spectra of a symmetric absorber/dielectric/ absorber configuration with the layer sequence 20 nm Ag, 90 nm SiO₂, 20 nm Ag for different angles of incidence θ between 0 and 60°;

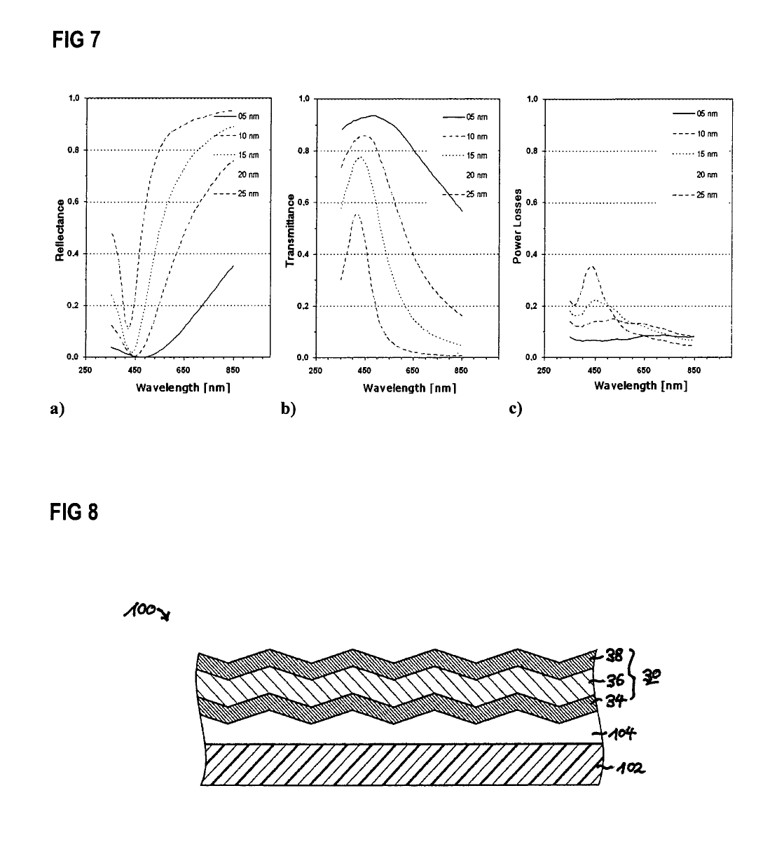

FIG. 7 reflection-, transmission- and absorption spectra of a symmetric absorber/dielectric/ absorber configuration with the layer sequence Ag, 90 nm SiO₂, Ag for an incidence angle θ=30°, whereby the thickness of the two Ag layers was varied between 5, 10, 15, 20 and 25 nm;

FIG. 8 a see-through security element according to an embodiment example of the invention, in which the thin-film element is combined with a hologram embossed structure.

The invention will now be explained by the example of security elements for banknotes.

FIG. 1 shows a thin-film element according to the invention, which is surrounded by a micro-optic relief structure. The manufacture of this micro-optic element can take place as follows:

A nanostructured substrate surface (a relief grating or an aperiodic relief such as e.g. a moth-eye structure) is covered with photoresist, so that a planar surface results. Subsequently in a photolithographical process (e.g. with the aid of a laser writer) predefined regions are exposed. After removal of the exposed photoresist the nanostructure is partly uncovered. The unexposed regions in contrast form planar surfaces, corresponding to the middle region of the element of FIG. 1. Finally the thin-film element is vapor-coated in accordance with the above explanations and advantageously lined with a lacquer layer or a cover foil. This thin-film element shows a gold color in the planar regions. The relief-shaped regions in contrast appear in a different color or these regions are black-absorbing.

In FIG. 1 “R” designates the reflection, i.e. the reflected part of the incident light, and “T” the transmission, i.e. the transmitted part of the incident light.

FIG. 2 shows for this purpose a schematic representation of a banknote 10 with a through opening 14 that is covered with a see-through security element 12 according to the invention. FIG. 3 shows the see-through security element 12 along the line II-II of FIG. 2 in cross section.

The see-through security element 12 contains a motif 16 that is represented in FIG. 2 for illustration as a coat-of-arms motif 16. In other designs, however, the motif 16 can represent any desired patterns, characters or codings, in particular also an alphanumeric sequence of characters, such as the denomination of the banknote 10. Upon viewing the see-through security element in incident light, with the viewer 22 disposed on the same side as the incident light 20, the motif 16 produces a gold-colored visual impression.

In contrast, upon viewing the see-through security element 12 in transmitted light (viewing position 24), for example by holding the banknote 10 in front of a light source or against the daylight, the motif 16 appears to the viewer 24 with a strong, blue color that hardly changes with the tilting angle of the banknote 10.

The saturated and strong blue color impression upon seeing through of a security element that appears gold-colored in incident light contradicts the usual viewing habits and thus has a high attention value and recognition value.

FIG. 4 shows in a CIE standard chromaticity diagram the reflection as a function of the angle of incidence θ=0°-60° for the layers: (661) Au; (662) 10 nm Al, 120 nm SiO₂, 10 nm Al; (664) 20 nm Ag, 90 nm SiO₂, 20 nm Ag; and (665) 70 nm ZnS, 80 nm SiO₂, 100 nm ZnS. The black spot designates the white point. For calculating the color values the optical constants from the standard literature were used. In the case of experimentally manufactured thin layers the refractive indices could, however, deviate slightly from these values due to the manufacturing method. So as to achieve the maximal saturation in the gold color tone, the thickness of the dielectric spacer layer should be adjusted within the tolerances specified above.

FIG. 5 shows in a CIE standard chromaticity diagram the transmission as a function of the angle of incidence θ=0°-60° in the chromaticity diagram for the layer configurations (662) 10 nm Al, 120 nm SiO₂, 10 nm Al, (664) 20 nm Ag, 90 nm SiO₂, 20 nm Ag and (665) 70 nm ZnS, 80 nm SiO₂, 100 nm ZnS. The black spot designates the white point. Like in FIG. 4 for calculating the color values the optical constants from the standard literature were used.

So as to produce the mentioned color effects, the see-through security element 12 with reference to FIG. 3 contains a transparent plastic foil 32 on which there is applied a three-layer, symmetric thin-film element 30 in the form of the desired motif 16. The thin-film element 30 consists of a first semitransparent mirror layer 34 which in the embodiment example is formed by a 20 nm thick silver layer, a dielectric spacer layer 36 which in the embodiment example is formed by a 90 nm thick SiO₂ layer, and a second semitransparent mirror layer 38 which in the embodiment example is formed by a further 20 nm thick silver layer.

The essential contribution to the coloration comes from the Fabry-Perot resonances which are formed between the thin semitransparent mirror layers. This effect is explained in more detail by means of reflection-, transmission- and absorption spectra of unpolarized light. FIG. 6 shows the spectra of the three-layer system 20 nm Ag, 90 nm SiO₂, 20 nm Ag for different angles of incidence θ between 0 and 60°. It is obvious here that the transmission maximum with reference to the peak in the absorption and with reference to the trough in the reflection is hardly shifted for increasing angles of incidence. Thereby a color impression is created that is uniform and independent of the viewing angle. The three-layer system shows a gold color tone in reflection and a blue color tone in transmitted light.

FIG. 7 shows an examination of the influence of the thickness of the semitransparent mirror layers. There are shown reflection-, transmission- and absorption spectra of a symmetric absorber/dielectric/absorber configuration with the layer sequence Ag, 90 nm SiO₂, Ag for an angle of incidence θ=30°, whereby the thickness of the two Ag layers was varied between 5, 10, 15, 20 and 25 nm. It is obvious that the position of the resonance is hardly influenced by the thickness of the semitransparent mirror layers. However, the thickness is indirectly proportional to the full width at half maximum of the resonance. A full width at half maximum of the resonance in a range of 70 to 150 nm in the spectrum provides an optimal color contrast. So as to simultaneously achieve a high color intensity in the reflection, in this layer configuration in particular a thickness of the semitransparent mirror layer of 20 nm Ag is suitable.

The embodiment example of FIG. 8 shows a see-through security element 100 in which a thin-film element according to the invention is combined with a hologram embossed structure.

For this purpose first a transparent embossing lacquer layer 104 with the desired hologram embossed structure was applied on a transparent foil substrate 102. After applying a not shown primer layer then a thin-film element with interference layer configuration, such as a thin-film element 30 of the type described with reference to FIG. 3, is vapor-deposited on the embossed structure. In this fashion the optically variable effects of the hologram embossing structure can be combined with the above-described striking reflection- and transmission color effect (i.e. the color effect in plan view and in transmitted light). For example the thin-film element in the window of a banknote can appear in the form of a forwardly or backwardly bulged number or a forwardly or backwardly bulged symbol.

1-15. (canceled)

16. A thin-film element for security papers, which, upon viewing in incident light, appears gold-colored, comprising:
at least two semitransparent mirror layers, and
at least one dielectric spacer layer arranged between the at least two mirror layers, so that, upon measuring the transmission of unpolarized light in the blue wavelength range from 420 to 490 nm there is exhibited a resonance with a full width at half maximum of 70 to 150 nm.

17. The thin-film element according to claim 16, wherein the resonance is the only resonance in the visible range.

18. The thin-film element according to claim 16, wherein the two mirror layers comprise silver or a silver alloy and the dielectric spacer layer has a thickness h and a refractive index v that fulfills the relation 120 nm<h*v<170 nm.

19. The thin-film element according to claim 16, wherein the two mirror layers comprise silver or a silver alloy and the dielectric spacer layer with a thickness h and a refractive index v fulfill the relation 340 nm<h*v<400 nm.

20. The thin-film element according to claim 16, wherein the two mirror layers comprise aluminum or an aluminum alloy and the dielectric spacer layer has a thickness h and a refractive index v that fulfill the relation 120 nm<h*v<190 nm.

21. The thin-film element according to claim 16, wherein the two mirror layers comprise ZnS or TiO₂; the dielectric spacer layer has a thickness h and a refractive index v that fulfill the relation 100 nm<h*v<170 nm; and v is smaller than the refractive index of the mirror layer.

22. The thin-film element according to claim 18, wherein the dielectric spacer layer is formed of SiO₂ and the dielectric spacer layer includes a semitransparent layer formed of copper.

23. The thin-film element according to claim 16, wherein the two mirror layers comprise a semimetal.

24. The thin-film element according to claim 23, wherein the dielectric spacer layer is formed of SiO₂.

25. The thin-film element according to claim 16, wherein the thin-film element appears blue upon viewing in transmitted light and has almost no color-shift effect.

26. The thin-film element according to claim 16, wherein the thin-film element is in the form of patterns, characters or a coding.

27. The thin-film element according to claim 16, wherein the thin-film element is combined with a relief structure.

28. A see-through security element for security papers comprising a carrier and with the thin-film element recited in claim 16 applied on the carrier.

29. A data carrier with the thin-film element as recited in claim 16, in which the thin-film element is arranged in or above a transparent window region or a through opening of the data carrier.

30. The data carrier according to claim 29, wherein the data carrier is a value document.
